(19) United States
(12) Patent Application Publication
(10) Pub. No.: US 2016/0086123 A1
(43) Pub. Date: Mar. 24, 2016

(54) METHODS AND SYSTEMS FOR EVALUATING JUDICIAL SYSTEM

(71) Applicant: RESEARCH CENTER FOR JUSTICE STANDARDS LTD., Mexico (MX)

(72) Inventors: RODOLFO NIEBLAS CASTRO, Mexico (MX); Victor Manuel Castro Borbon, Mexico (MX); Pedro de Keratry Nassar, Mexico (MX)

(73) Assignee: RESEARCH CENTER FOR JUSTICE STANDARDS LTD., Mexico (MX)

(21) Appl. No.: 14/864,837

(22) Filed: Sep. 24, 2015

Related U.S. Application Data
(60) Provisional application No. 62/054,711, filed on Sep. 24, 2014.

(51) Int. Cl. G06Q 10/06; G06Q 50/26

(52) U.S. Cl. CPC G06Q 10/06393; G06Q 50/26

(57) ABSTRACT

The present invention discloses a method for evaluating, monitoring, and improving judicial system performance. Methods of the present invention are capable of evaluating any judicial center regardless of jurisdiction. The evaluation score generated according to methods of the invention is capable of being compared directly. Also disclosed are computer information systems and computer-implemented methods for carrying out the evaluation, monitoring, and improving method.

### CROSS-REFERENCE TO RELATED APPLICATIONS

This application claims priority under 35 U.S.C. §119(e) and the benefit of U.S. Provisional Application No. 62/054,711, filed Sep. 24, 2014, and entitled, “METHOD FOR EVALUATING JUDICIAL SYSTEMS”, the entire disclosure of which is incorporated herein by reference.

### FIELD OF THE INVENTION

This disclosure relates generally to the field of judicial performance measurement and operational management. More particularly, the present invention relates to systems and methodologies for evaluating, rating, and certifying centers of justice, including courts, legal systems, tribunals and any other bodies that exercise judicial power.

### BACKGROUND OF THE INVENTION

Judicial systems play very important roles in the governments of the world. It is now well recognized throughout the world that sustained economic and social progress cannot be achieved without respect for the rule of law, democratic consolidation, and effective human rights protection. Each of these prerequisite conditions for social and economic progress requires a well-functioning judiciary that can interpret and enforce the laws equitably and efficiently. Ideally, a well-functioning judiciary should be predictable in its application of the law, timely in its resolution of disputes, and accessible to the public.

Throughout the world, there is an exceptional diversity of judicial and legal systems among different jurisdictions. However, one common theme is that many countries find that their judiciaries make inconsistent case law rulings and carry a large backlog of cases. The inefficiencies and inconsistencies of the judiciary erode individual and property rights, which greatly impede private sector growth and may even violate human rights. In particular, delays in case resolution affect both the fairness and the efficiency of the judicial system, resulting in weakened democracy and human rights. As the saying goes “justice delayed is justice denied.”

To address these issues, governments across the world have been launching judicial reforms. They are searching for ways to improve access to justice by increasing the fairness and efficiency of dispute resolution. To this end, governments are demanding comparative court performance data to quantitatively and qualitatively monitor and evaluate reforms. Analysis of the data will in turn assist governments to design and plan future reforms. This performance monitoring involves both comparisons within a specific country over time as well as comparisons across countries. In addition to governments, civic society and intergovernmental entities interested in promoting judicial accountability and transparency are increasingly demanding such performance metrics. Thus, a need has arisen for analytical tools to aid in the evaluation of judicial systems.

Despite this growing demand for court performance analytics, there is currently very little quantitative data on judicial efficiency or other analytical data on judicial systems available, making assessment of judicial reforms difficult. While individual jurisdictions have generated large volumes of statistical data about their judicial systems, the measurement metrics are typically specific to the jurisdiction and may have different definitions of judicial efficiency. This makes it difficult to assess the effectiveness of reforms and identify best practices so that different judicial systems can learn from each other's experiences.

Using as an illustrative example, the popular court performance measurement tool CourTools defines 10 measurements, each with a measurement plan, instrument and result reporting strategy. FIG. 1 shows a screenshot of CourTools' website that lists the 10 measurements it specifies and web links to the associated measurement instruments. As it is generally understood in the art, measurement instruments are tools for consistently implementing a scientific protocol to obtain data from respondent. For most social and behavioral surveys, such instruments typically involve questionnaires that provide scripts for presenting a standard set of questions and response options. They may typically be implemented in paper format, but may also be presented in electronic formats such as electronic spreadsheet, smartphone apps, etc. FIG. 2 shows a screenshot of an exemplary instrument for measuring “Access and Fairness”. FIG. 3 shows a screenshot of an exemplary spreadsheet tool for collecting, tabulating, and reporting measurement data from the survey instruments.

In one example scenario in which CourTools can be used, everyone in the court on a typical day is asked to fill out a brief self-administered survey (the measurement instrument in this example) as he or she exits the courthouse. The survey may present questions relating to respondents' perception of whether he was treated fairly and respectfully in the court room. The response option may be in the form of a number scale with 0 being strongly disagree and 5 being strongly agree. Results are collected, analyzed, and reported as a measurement of the court's performance.

Because different courts may use different survey and ask different questions, the results from different surveys are often tied to the questions asked on the survey and difficult to interpret beyond the limited circumstances they are set up for. For example, an average rating of 5 for a court on the “Access and Fairness” metric does not necessarily mean that it performed better than another court that may have a rating of 3 on a different set of survey questions.

In addition, tools such as CourTools lack universal applicability. For example, while conventional civil trial courts may employ CourTools as a performance measurement tool, other courts such as criminal or specific drug enforcement courts cannot similarly adopt CourTools because of the differences in the nature of cases handled by the two types of courts. CourTools must be set up for and tailored to each circumstance to which it is applied. For example, in conventional civil courts, quick disposal is generally considered a good performance indicator. However, in a more specialized drug enforcement court, participants usually require much more time to resolve their case simply because the nature of addiction and drug abuse treatment, which can require much longer periods of time for the ultimate resolution of a given case.

Therefore, there exists an urgent need for a more universally applicable method and system of evaluating judicial systems. It is further desirable to enable data analytics in such a system to further aid in the evaluation of various judicial systems.

### SUMMARY OF THE INVENTION

In light of the above highlighted needs in the area of judicial system evaluation, it is one goal of the present invention to provide a universal method for evaluating judicial centers, such that the rating system allows for the results of the evaluation to be directly compared to each other. It is noted however, that some embodiments of the described evaluation system may allow for greater comparison accuracy between certain judicial centers than others.

It is another goal of the present invention to provide a system and technology platform that can implement the rating system to serve as a component of a judicial center's operational management and process improvement system. Some of the described embodiments are geared towards serving this goal.

Embodiments of the present invention are able to overcome the above described problems in the art, such as the non-universal applicability of earlier systems, by integrating and synthesizing performance standards to generate a composite rating for any judicial center on a common scale that can be compared across different jurisdictions. More specifically, the universally applicable judicial performance evaluation method and system disclosed herein solves the above described long standing problem in the art by combining performance measurement standards from different standard-setting bodies to form a scoring matrix that can be applied to quantitatively evaluate any judicial center as well as diagnose performance bottlenecks. In the present invention, the heterogeneity of measurement standards throughout the world is no longer a problem. It respects the different measurement standards currently in practice in a jurisdiction and draws from this diverse source of measurement standards to provide a new yardstick for the rapid computation of a composite rating for any judicial center on a common scale.

Accordingly, in one aspect, the invention is directed to methods and systems for determining a performance rating for a judicial center. Methods in accordance with embodiments of the invention may generally include the steps of receiving performance data of the judicial center into a computer system wherein the computer system has a memory unit and a processing unit programmed to perform the steps of: assigning each data point to a topic; compute a standard score and a topic score; determining a rating for the center based on the standard score and the topic score; and rendering a report.

In some embodiments, the performance data may each represent a performance standard applicable to the judicial center. Performance standards are typically set and published by standard setting bodies generally known in the art. Alternatively, performance standards may also be set and adopted by the judicial center. Exemplary standard setting bodies may include but not limited to National Center for State Court (NCSC), Ibero-American Summit of Presidents of Supreme Courts, and the like. In some embodiments, the standards are selected a standard published by at least 1 of the 9 RCJS sources as defined in the detailed description. In a preferred embodiment, the standards are selected from the RCJS standard set as defined in the detailed description. In a still preferred embodiment, the standards consist of the entire RCJS standard set.

In some embodiments, the topics may be selected from the RCJS topic set as defined in the detailed description. In some preferred embodiment, the number of topics is at least 4. In a preferred embodiment, the topics consists of “access to justice,” “independence,” “transparency,” and “efficiency and effeteness.”

In some embodiments, assignment of the performance data is performed according to a pre-determined mapping rule stored in the memory unit of the computer system. In some preferred embodiment, the mapping rule may be the RCJS mapping rule as defined in the detailed description.

In an alternative embodiment, a step of assigning the topics to categories may also be included. Categories may include quantitative topic, qualitative topic, and the like, but are not limited thereto.

In some embodiments, standard score is a percentage score representing the percentage of standards for which the judicial center is in compliance. In other embodiments, topic score is a percentage score representing the percentage of standards assigned to the topic for which the judicial center is in compliance.

In some embodiments a rating score is a letter score consisting of the ratings A, B, and C. In one embodiment, an “A” rating is determined if the standard score is greater than 90% and at least 3 of the topic scores is greater than 95%, a “B” rating is determined if the standard score is between 75% and 90%, and at least 2 of the topic scores is above 95%, a “C” rating is determined if the standard score is between 50%-75% and at least 1 topic score is above 95%.

In some embodiments, the rating score determination further requires additional conditions, including but not limited to a documented commitment by the judicial center to maintain the standard and topic scores at or above the level required for the rating.

In some embodiments, the report may be rendered on a printed form. In other embodiments, the report may be rendered on an electronic display. Reports are generally generated in human-readable form. In some embodiments, the report will include a performance analysis including the rating score, and any performance deficiencies in the judicial center according to a pre-determined performance target of the judicial center. For example, a judicial center may have a pre-determined performance target in a topic such as “access to justice” to be above 95%. If the judicial center's actual topic score is below 95%, the report may include a detailed breakdown of the data points that went into this topic score.

In those embodiments where the report is rendered on a display, the report may be provided in interactive form with user interfaces. Exemplary user interfaces may optionally include interactive elements for performing data entry, selecting rating scores for comparison, displaying real-time changes in the rating score. In some preferred embodiments, the user interface further comprises elements for performing interactive performance analysis on the performance data. In another preferred embodiment, the interface interactive performance analysis may include multi-dimensional analysis. Exemplary multi-dimensional analysis may include clustering, regression, and the like, but not limited thereto.

In some embodiments of the invention, the methods and system can be configured to compare the performance of various judicial centers. In some embodiments, the method and system of the invention can be configured to include the steps of obtaining a composite rating for a plurality of judicial centers in accordance with a computer-implemented method as described above; arranging the ratings in a human-readable representation selected from a list, a table, a chart, a graph, or a combination thereof.

In another aspect, the invention is directed to a computer-readable medium. In some embodiments, a computer-readable medium in accordance with this aspect of the invention will generally include codes to instruct a processor to perform the following steps when executed: receiving performance data of the judicial center into a memory unit; mapping each performance data point to a topics selected from RCJS topic set; computing standard score and a topic score; determining a rating score for the justice center based on the topic scores and the standard score; and transmitting to an output unit one or more of the scores when the processing unit receives an instruction to transmit the one or more scores.

Various possible options and alternative embodiments of the performance data, selection of performance standards and topics, score determination and performance data to topic mapping are as described above.

In another aspect, the invention is directed to a computer-implemented system for monitoring and improving the performance of a judicial center. In some embodiments, a system in accordance with this aspect of the invention will generally include a performance evaluation subsystem comprising a memory unit and a processing unit programmed to perform the steps of: receiving performance data of the judicial center(s) via an input unit; mapping each performance data point to a topic selected from the RCJS topic set, wherein said mapping is performed in accordance with a set of predetermined mapping rules stored in the memory unit; computing a standard score and a topic score for each topic; determining a rating score for the justice center(s) based on the topic scores and the standard score; and transmitting to an output unit one or more of the scores when the processing unit receives an instruction to transmit the one or more scores.

In some embodiments, methods for improving judicial performance may include the steps of changing an operational parameter of the judicial center; generating performance data using a pre-selected set of standards applicable to the center; obtaining a performance report from the system; and retaining the change of the operational parameter or procedure if the report indicates a satisfactory level of performance. Alternatively, if the performance score is unsatisfactory, the change may be discarded.

Operational parameters may be any aspect of the judicial center's operation, including but not limited to personnel, infrastructure, location, budget, etc.

Efforts for improving judicial performance utilizing systems and methods described herein are particularly effective as changes can be guided by evidence and iterated. Multi-dimensional analysis may further assist analysis and identification of factors that truly impact the performance of the judicial system. For example, regression analysis may be performed using the performance data as input.

Other aspects and advantages of the invention will be apparent from the following description and the appended claims.

### BRIEF DESCRIPTION OF THE DRAWINGS

FIG. 1 shows an exemplary screenshot listing the 10 performance measurements of the prior art performance measurement tool CourTools.

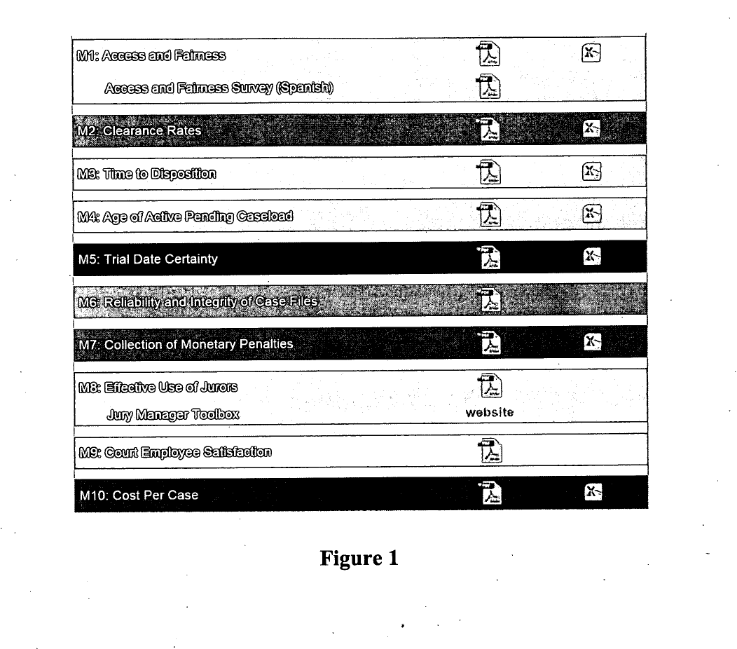

FIG. 2 shows a screenshot of an exemplary instrument for measuring “Access and Fairness” in accordance with the prior art performance measurement tool CourTools.

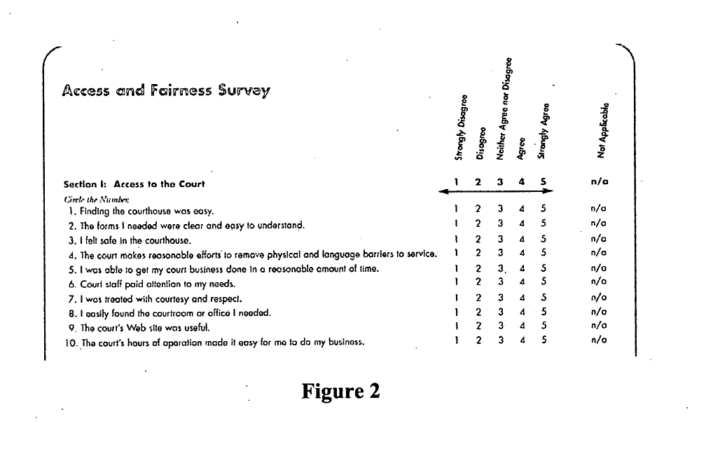

FIG. 3 shows a screenshot of an exemplary electronic spreadsheet tool for collecting, tabulating, and reporting measurement data from the instrument of FIG. 2.

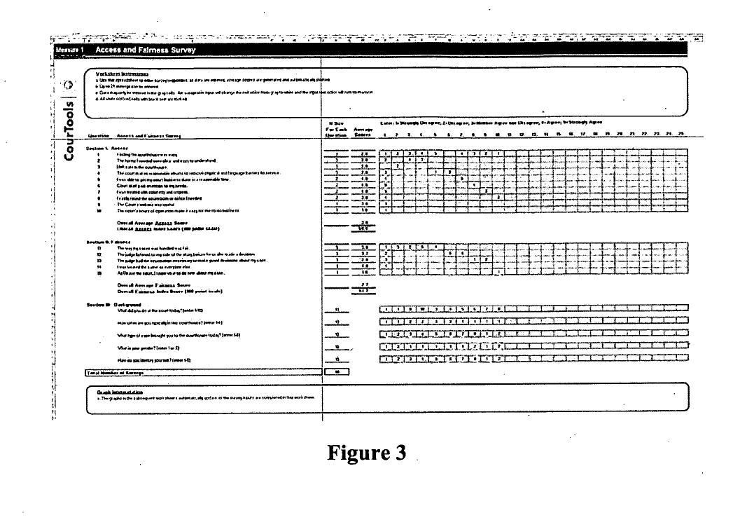

FIG. 4 shows a flowchart diagram illustrating an exemplary process for determining a performance rating score in accordance with some embodiments of the present invention.

FIG. 5 shows a flowchart diagram illustrating an exemplary process for improving judicial performance in accordance with embodiments of the invention.

FIG. 6 shows a schematic representation illustrating an exemplary judicial performance certification service model in accordance with embodiments of the present invention.

FIG. 7 illustrates an example of a suitable computing system environment 200 on which methods and features of the invention may be implemented.

FIG. 8 shows a schematic diagram for an exemplary system in accordance with embodiments of the present invention.

### DETAILED DESCRIPTION

### Judicial Performance Measurement in General

Modern judicial centers are busy places. A vast array of different case types in all stages of the legal process simultaneously compete for the time and attention of administrators, judges, and staff. Satisfying the expectations of judicial center customers and stakeholders is a daunting challenge. Moreover, judicial leaders and administrators only have very limited opportunities to view their work in perspective. The unrelenting pressure of caseloads, along with everyday operational problems can be all consuming. In this context, performance assessment plays an increasingly critical role in helping judicial centers to set goals as well as understand and manage organizational performance. With performance indicators in place, administrators and other stakeholders can gauge how well the center is achieving basic goals such as access and fairness, timeliness, and managerial effectiveness.

As used herein, the term “judicial performance standard” refers to a measurable goal for a judicial center. Throughout the specification, this phrase may also be referred to simply as “performance standard,” or “operational standard,” or simply “standard.” The synonymous meaning of these variations of the phrase will be made apparent to those skilled in the art through the context of their usage. For example, performance standards may establish goals for effective judicial center performance in an area or topic that may be an issue of concern or a factor for which a judicial center is expected to be judged on, including, but not limited to access to the center, timeliness, fairness, integrity, independence, accountability, and public trust.

Throughout this specification, the term “judicial performance topic” may be used as a shorthand to refer to an issue, a concern, or a factor for which a judicial center is expected to be judged on. It may also sometimes be referred to as “topic” or “area.” The meaning will be apparent to those skilled in the art from the context.

As used herein, the term “judicial performance indicator” refers to a quantitative or qualitative value that reflects the operational status of a judicial center with respect to a performance standard. For example, “current average time to case disposal” may be a performance indicator reflecting a performance standard for efficiency.

There are a number of government, public, and private organizations dedicated to establishing judicial performance standards. They may serve a narrowly targeted niche such as civil or criminal trial court, or they may have a broader mission in setting international best practice standards. Some common objective of these organizations include: establishing a common language for the description, classification, and communication of judicial center activities, establishing a conceptual framework for understanding and improving judicial center performances, and providing tools for judicial centers to conduct self-assessment, self-improvement, and accountability to the public.

To achieve these objectives, those in the art often define “performance areas” or “topics” for which they wish to develop standards and measurements. For example, the organization National Center for State Courts (NCSC) has identified five common “performance areas” or “performance topics” for which the performance of trial courts will be judged. These five topics are “access to justice,” “expedition and timeliness,” “equality, fairness, and integrity,” “independence and accountability,” “public trust and confidence.”

To assess the performance status of a judicial center in a performance area or topic, a standard setting body such as NCSC will articulate specific standards or goals for that performance area or topic. Some example standards may include “establishing and complying with recognized guidelines for timely case processing, while keeping current with incoming caseloads,” for the topic “expedition and timeliness,” and “taking appropriate responsibilities for the enforcement of court orders” for the topic “equality, fairness, and integrity.”

In practice, performance standards may be selected and linked to a set of “performance measures,” which may employee a variety of data collection methods, including, but not limited to: case and administrative record reviews and searches, survey instruments, interviews, observations and simulations, or any other common data collection method known in the art.

Performance areas, standards, and measures will generally be published by standard setting bodies or individual judicial centers in written form to facilitate adoption and implementation. One example of such publication is the Trial Court Performance Standards and Measurement System (TCPS) which covers both the performance standards and the measurement system, including rationale and detailed instructions for conducting the 68 measures of court performance. It also includes an introduction that describes the development, testing, and demonstration of TCPS. The content of TCPS is incorporated herein in its entirety.

The aforementioned standard “establishing and complying with recognized guidelines for timely case processing, while keeping current with incoming caseloads” is actually one example standard defined in TCPS (TCPS Standard 1.2).

These various measures provide volumes of quantitative and qualitative data on the various aspects of a judicial center's performance. However, as helpful as these individual measures may be to answering the performance questions they were designed to do, there is currently a lack of available methods that can synthesize these data to provide a comprehensive and holistic view of the operational status of a judicial center. Methods and systems for comparing and rating the performance of judicial centers across all jurisdictions is also notably absent. Formulation of such a method and system poses considerable technical challenge due to the fact that the measurements and data are truly diverse and defy direct quantitative comparison.

### Theoretical Foundation

In some embodiments, this invention discloses methods for synthesizing the vast diverse set of judicial performance standards to give a simple, easily comprehensible rating system that is applicable to all judicial centers regardless of which jurisprudence tradition it is in.

To illustrate, consider a conventional performance measurement tool that may provide a standard to evaluate the efficiency of a court. The standard may require measuring the average time to case disposal. While this measurement may be useful for the court for a subjective sense of how the court is handling its caseload, it provides little guidance as to how the court is functioning as a whole or how it really compares relative to other courts in a holistic sense. Instead of comparing the measurements directly, methods in accordance with embodiments of the invention do not compare the measurement directly, but summarizes the standard as either “in compliance” or “not in compliance.” The threshold of compliance may be set of a standard setting body or the judicial center. This way, regardless of the underlying unit of measurement, all standards that apply to a judicial center is common-sized to a binary summary of “in compliance” (may be represented by “1”) and “not in compliance” (may be represented by “0”). Collectively, these common-sized values form a multi-dimensional matrix of binary values representing a state of the judicial center's performance. These multi-dimensional matrices can then be summarized, characterized, and compared to each other on a common rating scale. Further, this formulation also opens the door for multi-dimensional analysis such as regression or other time-series analysis of the performance.

To further facilitate this approach of data synthesis, Table 1 discloses a set of 18 topics herein referred to as the “RCJS topic set.” Table 1 further show number of standards from each of the five common performance tools that map to each of the 18 topics. This mapping provides another dimension for analyzing and comparing the performances of judicial centers. Another embodiment is shown in Table 2. Other topic selections may also be defined.

The following exemplary mathematical formulation describes in detail how this approach may form the basis of an exemplary rating scheme.

### Illustrative Letter-grade Judicial Performance Rating Algorithm

There exist a fixed number of standards for evaluation of justice centers. Given a justice center Cₖ, there exists a fixed number of subjects required for evaluating Cₖ, which are denoted as N, or more precisely as N_{C}, (because N_{C} is dependent on C). Accordingly, let Cⱼ be a justice center such that there are N_{C} required topics to be considered in evaluating Cⱼ. We seek a formula that will help us assign a rating for Cⱼ as follows:

To obtain a “C” ranking, Cⱼ must cover between 50%-75% of the N_{C} required topics. Additionally at least one of the N, required topics must be covered at least 95% by Cⱼ.

To obtain a “B” ranking, Cⱼ must cover between 75%-90% of the N, required topics, and at least two of the N required topics must be covered at least 95% by Cⱼ.

To obtain an “A” ranking, Cⱼ must cover more than 90% of the N, required topics, and at least 3 of the N required topics must be covered by at least 95% by Cⱼ.

Let T₁, T₂, . . . , T_{N}, be the required topic for justice center Cⱼ. In a preferred embodiment, topics may be selected from the RCJS topic set. Each of these required topics comprises a series of standards, for example: let required topic T₁ be the set of required standards {e_{1,1}, e_{2,1}, . . . , eᵣ_{_{1,}}₁} such that T₁={e_{1,1}, e_{2,1}, . . . , eᵣ_{_{1,1}}} where r₁ is the number of required standards in required topic T₁. The standard to topic assignment may be intrinsically determined by the standard setting body that defined the standard or may alternatively determined by a rating agency or a user performing the rating. Accordingly, any required topic Tᵢ is defined as the set of required standards {e_{1,i}, e_{2,i}, . . . , eᵣ_{_{i,}}ᵢ} such that Tᵢ={e_{1,i}, e_{2,i}, . . . , eᵣ_{_{i,}}ᵢ} where rᵢ is the number of required standards in required topic T. More generally, Tᵢ={e_{j,i}, |1≦j≦r₁} where rᵢ is the number of required standards for required topic Tᵢ.

Accordingly, let E be the union of all required standards for required topic Cⱼ. We define the function f_{C}_{₁}:E→{0,1}, such that for each required standard e that is an element of E(e∈E), f_{C}_{ⱼ}(e)=0 if Cⱼ does not comply with standard e, and f_{C}_{ⱼ}(e)=1 if Cⱼ complies with required standard e. Accordingly, let rᵢ¹ be the number of required standards in required topic Tᵢ that evaluates to “1” under the function f_{C}. Put another way, rᵢ¹=Σₓ₌₁^{r}^{ᵢ}f_{C}_{₁}(e_{x,i}). It follows that pᵢ can be defined as the percentage of required standards in required topic Tᵢ that are met in justice center Cⱼ, or pᵢ=rᵢ¹/rᵢ.

The following functions are also instructive:

fₚ:[0,1]→ [symbol] given by:

$${f}_{p} ( x ) = \{ \begin{matrix}0 if x ∈ [ 0 , \frac{1}{2} ) \\ 2 if x ∈ [ \frac{1}{2} , \frac{3}{4} ) \\ 3 if x ∈ [ \frac{3}{4} , \frac{9}{10} ) \\ 1 if x ∈ [ \frac{9}{10} , 1 ]\end{matrix} \\ {ℊ}_{p} \text{:} [ 0 , 1 ] \to ℤ given by \text{:} \\ {ℊ}_{p} ( x ) = \{ \begin{matrix}0 if x ∈ [ 0 , \frac{19}{20} ) \\ 1 if x ∈ [ \frac{19}{20} , 1 ]\end{matrix}$$

The function fₚ allows for rapid classification of justice center Cⱼ. It can be observed that if Cⱼ has more than 50% of all required standards in each of the required topics, then fₚ results in 3, 2, or 1 for each required topic, depending on the percentage of required standards met within that required topic. Accordingly, if at least 75% of all of the required standards within each of the required topics are met by justice center Cⱼ, fₚₚ will result in 3 or 1 for each required topic. Similarly if 90% or more of the required standards in each of the required topics are met by justice center Cⱼ , the fₚ results in 1 for every required topic.

Function gₚ serves to identify the number of topics for the number of required standards within each required topic is met by justice center Cⱼ by at least 95%.

Accordingly, in order to quickly calculate the proper categorization of justice center Cⱼ we define the following product F and sum G:

F=Πᵢ₌₁^{N}^{_{C}}fₚ(pᵢ)

G=Σᵢ₌₁^{N}^{_{C}}gₚ(pᵢ)

Product F is the product of fₚ(Pᵢ) for 1≦i≦N_{c}. Likewise, G is the sum of gₚ(pᵢ) for 1≦i≦N_{c}.

There are four relevant resultant cases:

If F=1, it means that fₚ(Pᵢ)=1 for 1≦i≦N_{c}. In other words, justice center Cⱼ meets at least 90% of the required standards in each required topic. If G≧3, then at least three required topics have 95% or more of their required standards met by justice center Cⱼ. Under such circumstances, justice center Cⱼ has qualified for an “A” rating.

If F>1, and F is not even (in other words, for ∀k such that 1≦k≦N_{c}, fₚ(Pₖ)≠2), then justice center Cⱼ meets at least 75% of all the required standards for every required topic. Accordingly, if G≧2, there are at least two required topics where justice center Cⱼ meets at least 95% of the required standards. Accordingly, justice center Cⱼ has qualified for a “B” rating.

If F>1, and F is even, then there exists at least one required topic Tₘ, such that 1≦k≦N_{c}, fₚ(Pₖ)=2. In other words, at least one required topic has only 50%-75% of its required standards met by justice center Cⱼ. If G≧1, then there is at least one required topic where justice center Cⱼ meets at least 95% of the required standards. Accordingly, justice center Cⱼ has qualified for a “C” rating.

Finally, if F=0 then at least one required topic has less than 50% of its required standards met by justice center Cⱼ, and therefore justice center Cⱼ does not qualify for a rating. Similarly, if G=0 then there are no required topics that have at least 95% of their standards met by justice center Cⱼ, and accordingly, justice center Cⱼ does not qualify for a rating.

The above exemplary algorithm shows a 2-level grouping of data into topics and standards. However, it will be understood by those skilled in the art that more levels of abstraction may be added. For example, topics may be further classified into categories to form a 3-level grouping rating algorithm to add additional dimensionality to the analysis.

### EXAMPLE 1

### Exemplary Letter-Grade Rating Algorithm

This exemplary rating algorithm integrates all the key experiences and recommendations that have been raised by worldwide experts, and organizations in practices that are distinguished by seeking better Administration of Justice, including among others: International Framework for Court Excellence (IFCE); The European Commission for the Efficiency of Justice (CEPEJ); Ibero-American Judicial Summit (CJI); Statute of the Ibero-American Judge; 100 Brasilia Regulations Regarding Access to Justice for Persons on condition of Vulnerability; Bill of Rights of Persons before the Ibero-American Judicial Justice Field; Minimum Rules for Legal Security in the Field Iberoamerican; Ibero-American Code of Judicial Ethics; Principles, Rules and Best Practices on the Relationship between the judicial authorities and the Media; Decalogue Iberoamerican to quality justice; Ibero-American Charter of Victims Rights; Global Measures of Court Performance; and CourTools.

This exemplary embodiment identifies 18 topics to be considered, correlating with categories, indicators and evidence that, taken together, allow one to carry out a multi-dimensional, quantitative and qualitative evaluation of the condition or the situation in which the Directors of Justice in any Justice Center (e.g. Court, Magistrates Court, or Judiciary) are found. This particular embodiment respects the existing measurement systems today to every precept of individualized systems, which have been agreed to, and accepted by all members of certain communities like Fair IFCE, CourTools, Global Measures, and countries that are members of the European Parliament, which accepted CEPEJ-Methodology. As noted above, the 18 topics identified in Table 1 are herein referred to as the “RCJS topic set.”

This exemplary embodiment further discloses in Appendix a detailed description of 487 standards and their corresponding assignment to one of four topics selected from the group consisting of “access to justice, transparency, efficiency and effectiveness, and independence.” The set of 487 standards disclosed in the Appendix is herein referred to as the “RCJS standard set.” The 9 sources of standards from which the 487 standards are drawn is referred to herein as the “RCJS sources.” In addition, the pair-wise standard to topic correlation as shown in the tables of the Appendix is herein referred to as the “RCJS mapping rule.”

### EXAMPLE 2

### International Rating Certification Model

We now describe in operational terms how the above letter-grade rating scheme may be formulated and used in the field to provide a rating certification service model in accordance with an exemplary embodiment of the invention. The goal of certification under this exemplary service model is to use the evaluation methods and systems of the present invention to effectuate judicial administration excellence and process improvement. In this example, an international institute (“the Research Center for Justice Standards” hereinafter called “Institute”) is established to act as the quality control authority of judiciaries in certifying the performance of judicial centers as well as providing guidelines and directives for improving the performance of judicial centers.

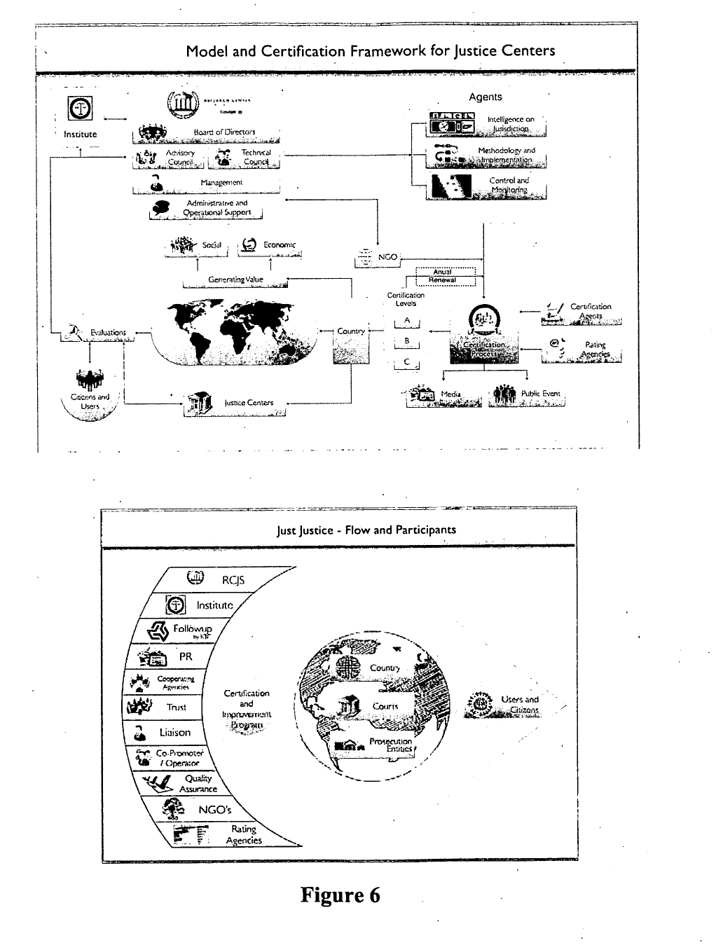

Referring to FIG. 6, the Institute may be comprised of an administrative council or board of directors, which may have executive decision making power to govern the Institute. The Institute may further comprise an advisory council which may collaborate with the administrative council, consultative council, or other authorities within the institute in order to advise the governance of the Institute. Specifically, the Advisory Council may comprise members having different specialties and expertise that may be relevant for the evaluation and certification of judicial systems or for the governance of the Institute. The Advisory Council may also provide consulting to the Institute on any topics or issues under consideration to assist in the decision making process. The Institute may also have a technical council, which may be qualified and competent to support and implement the certification process and related methods and methodology discussed below, including applying and discussing embodiments of the certification methodologies disclosed herein. The institute may further include an administrative and operations support, or rectory, which may be responsible for the management, deployment, and operation of all tasks necessary to run the Institute. Additionally, the institute may employ or contract administrative and operational support to fill any short or long term needs associated with its operation.

The Institute may employ or otherwise work with collaborative agents to assist in its operations, including the certification of judicial systems and centers. Such agents may be individuals or other entities, such as corporations. Specifically, the Institute may use or include jurisdiction research agents to perform tasks required for the certification process within the jurisdiction. Such agents may be primarily responsible for effectuating agreements with and commitments from the judicial systems to facilitate the certification process.

Agents may be further tasked with application and implementation of the various embodiments of a certification methodology, as described herein, including the control and monitoring of the one or more stages involved in the rating or certification process, such stages including possible milestones or achievements.

Agents may also assist with the implementation, control, and monitoring of the certification process and all tasks related thereto. Such tasks may include the implementation of a methodology to obtain and measure issues or topics, standards, and other metrics relevant to the certification process. Individuals suitable for the role of agents preferably are technologically capable, and who can facilitate the real-time monitoring and control of the certification process and any progress made thereunder. More specifically, the agents may assist with the measurement and evaluation of critical events related to the certification process, including events relevant to specific topics, categories, evidence of compliance or non-compliance with international best practices, progress, and deliverables.

Stages and activities undertaken in an exemplary certification process will generally take place via a set of integrated activities in three stages: initiation of the process, certification, and post-certification management. During each of the stages, there will be a number of well-defined tasks to complete. In an exemplary embodiment, a total of 20 tasks are set forth below.

Stage 1: Initiation. The first stage is Activities Prior to Certification. This stage includes six tasks: Liaison with Local Authorities, Preliminary Agreement, State of Affairs Assessment, Certification Project, Budget and Identification of Resources, and Commitment.

At this stage, the tasks may be assigned by the Institute to its Intelligence Agents who are located within the jurisdiction that is to be certified. Those agents will have or will obtain a preliminary understanding of the legal environment of the jurisdiction. The agents will work with the administrative authorities or other appropriate parties to formulate a certification plan for one or more judicial centers. The plan will generally include a project timeline, budget, study of the state of affairs, and commitment of the parties involved. For example, parties may agree to adopt certain set of practices, be evaluated according to certain set of standards, and implement certain process monitoring or case management tools, among others. In some embodiments, commitment may include adopting procedures or other practices to ensure that the judicial center(s) will comply with at least certain percentage of standards.

Liaison with Local Authorities. The Institute, through its Intelligence Agent in the jurisdiction will liaise with the authorities of the judiciary, the executive branch and any other one that needs to intervene to ensure the adoption of the best practices and/or international agreements for the Administration of Justice in the Jurisdiction.

Preliminary Agreement. Once the initial activity of Liaison with Local Authorities has been done, the Institute's agents may formalize such agreements with a contract or other legal instrument giving judicial certainty to the different actors and participants in the process of certifying the judicial center(s).

State of Affairs Assessment. Ideally, through the certification process, a judicial center will either be proven that it is already operating at the certified level or it will be brought up to standard in order to obtain the certified level. Therefore, a before-and-after comparison is important to show the effect of the certification process. This activity is to collect information and data regarding the administration performance of a judicial center before undergoing the certification process and after the certification process. The data collection may be done by the center or the Intelligence Agent.

Certification Program. The Certification Program establishes a basic plan for the certification process, including the number of justice centers to be certified, the basic information, scope and bounds of each, and each center's location, responsible authority, the time in which certification is to be carried out, and other such logistical consideration, but not limited thereto.

Budgeting and Identification of Resource. Based on the Certification Program, an estimated budget and identification of all recourses that will be needed is developed and established.

Commitment. Once the earlier steps have been completed, a contract for professional services between the Justice Center and the Institute and/or the Intelligence Agent is signed. Upon its execution, the certification process can begin.

Stage 2: Certification. The second stage involves the activities during the certification process, which include: Methodology Application and Enforceable Standards, Work Programs, Diagnosis, Areas of Opportunities; Coalescence of Solutions, Certification Pre-evaluation, Certification, Public Event and Media, and Rating Agencies Report. These activities may be adapted or adjusted to the specific needs of the certification in progress as need arises.

Methodology Application and Enforceable Standards. Referring to FIG. 6 again, the Institute, through its Agent, adapts and applies an exemplary letter-grade performance rating methodology in accordance with embodiments of the invention to a justice center that has completed all the preliminary tasks described above for the pre-certification Initiation stage. It will be understood by those skilled in the art that detail parameters of the rating methodology may be adjusted and modified by taking into account the existing legal framework of the jurisdiction and making appropriate adjustments to each of the centers to be evaluated. For example, in a country where multiple languages are spoken, the rating methodology may take into consideration whether a center provides language translation assistance. In contrast, in countries where a single language predominates, this requirement may not be included.

Work Programs. The rating methodology and its topics, standards, and other metrics are apportioned and applied in the certification process to evaluate activities, responsible authorities, deliverables, and execution time breakdown for the certification process. Specifically, this generally involves a detailed project execution plan and project tracking management system to ensure that all data required for certification are generated and collected.

Diagnosis and Identification of Opportunity for Improvement. The certification process will generate a collect a large volume of data regarding one or more judicial centers. In addition, the data synthesis approach will further provide the opportunity to diagnose systemic problems in the administration of the justice center that cannot be uncovered or difficult to uncover by conventional means. For example, by reducing all input data on the standards to a binary state (i.e., in compliance versus not in compliance) all standard measurements can be examined at once to uncover correlations between different standards. Providing this standard compliance information in real-time may further provide opportunities to correlate operational performance with events or factors external to the center's operation.

In one exemplary embodiment, performance data are gathered and input to a certification management system in real-time. A real-time certification level monitor (to be described below) is maintained in connection with an information source about stock market. The influence of stock market may then be correlated to performance of a judicial center and factors vulnerable to the market may quickly be identified in real-time.

Coalescence of Solutions. Once such opportunities are identified, solutions may be proposed to take advantage of the opportunities. Accordingly, the step of incorporating solutions into the justice center is added to the work program to implement the improvements identified by the agent in agreement and cooperation with the Justice Center. In this manner, the certification process can respond to the opportunity areas identified in the Justice Center.

Certification Pre-evaluation. A preliminary estimate of the assessment and impact of proposed solutions, in view of the existing conditions in the Justice Center is prepared to estimate the rating that may be achieved by the justice center. Current performance data collected during the Initiation stage will provide a snapshot of the performance rating level of the Justice Center. If the Justice Center is not currently operating at the desired rating level, an improvement plan is indicated. However, performance of a Justice Center is not determined by any single factor. It will be understood by those skilled in the art that the projected outcome of any improvement plan may only be an estimate. Continuous monitoring of the improvement plan is necessary to ensure the desired outcome is achieved.

Certification. Achieving the desired certification is the culmination of this stage. Once a Justice Center has been rated at the desired level or has implemented a solution plan to achieve the desired rating level, a “certificate of excellence” may be awarded by the Institute. This activity may be supervised by officials of recognized competence and prestige and clearly identifies the Justice Center as a center that has been certified by the Institute via the certification method in accordance with embodiments of the invention.

Public Event and Media. This task involves the public disclosure of the certification of the justice center to the general public. The results obtained by the Center for Justice may be expressed in a certificate delineating the certification issued by the Institute, may have an annual renewal, and support the implementation of standards and best practices outlined in the methodology by the Institute.

Rating Agencies Report. In this activity the Institute will give recognition to the granting of the certificate to the Justice Center certifying the rating that has been achieved by the justice center.

Stage 3: Comprehensive Management. The final stage is Management Integration to be completed after the certification process. This stage includes the following tasks: Incorporation of Methodology Tasks, Incorporation of Research Tasks, Milestone Identification, Technology Platform Installation, Operation and Monitoring, and Evaluation.

Fine Tuning Applicable Standards to the Certification. Subsequent to the certification, tasks and considerations used by the rating methodology during the certification process may be incorporated into the justice center's practices, such as providing online activities through multi-way interactive media, tracking of multiple management processes in real time, and continuing periodic evaluations of the topics required for the justice center to improve its certification rating.

Incorporation of Methodology. Subsequent to the certification, the Institute may reevaluate its selection and application of the required standards, the identification of topics, relationships between entities, and previous activities described in this method in order to continue to develop and improve the certification process, and such improvements may be communicated to the Justice Center for incorporation into its practices.

Identification of Milestones. The Institute or its agents may recognize and identify relevant events that may symbolize an important achievement in mainstreaming methodology and research tasks or the improvement of the judicial center's administration of justice under international best practices. These milestones may be identified and shared with the judicial center, the general public, and may form part of cross-jurisdictional studies and research. Exemplary events may include adoption of certain procedural practices that resulted in significant improvement in rating levels or other relevant events recognized as significant by those skilled in the art.

Upload Data to Information System. Information gathered from the Justice Center in the different steps of the certification process may be stored and preserved in a management technology platform in accordance with embodiments of the invention. The technology platform may include clients, servers, remote devices (including smart phones, tablets), monitors, printers, network connections, modems, and any other computing devices that may be used to provide input to the technology platform or receive output from same. The technology platform preferably includes a web site, which may have a graphical user interface allowing data to be input and output in an easy, user-friendly fashion. The technology platform may be present and used during each of the stages of the certification process to facilitate communication, data entry, information sharing, information control and processing, and may continue to remain available after the certification process for additional research, data-mining, or follow-up evaluations and re-certifications.

Supervision and Follow-up. Agents may continue monitoring the certification process and developments in the various criteria tracked thereunder by the technological platform that meets the standards mandated by the Institute. Such platform may allow queries and display results in real-time, including displaying the status of the situation, saved milestones, and monitoring information. The platform may allow the monitoring and sharing of the requested information to the Justice Center and other actors involved in the process via email, electronic communication, or other methods currently known in the art (including allowing such users direct or indirect access to the database where such information is kept).

Assessment. After a Justice Center is certified, evaluations may be performed by either the Institute, the Agent, or any interested party with authority to periodically access performance data and repeat evaluation. The data stored may also be used as source data for data-mining operations to consider the social and economic impact of the certification granted to the Justice Center. As part of these continuing evaluations, the perception of the justice center may also be measured at either or both of the levels of the citizen and population at large.

The certification process may be evaluated, assessed and accredited by non-governmental organizations (NGOS), individuals, or other suitable entities. Exemplary suitable entities may include prestigious non-profit organizations or institute.

As explained above, after the performance data are gathered and reduced to topic scores and standard scores, the scores may be used in combination with other parameters to determine a rating level. This particular example contemplates that there may be at least three different levels of certification criteria:

Level A may require that a justice center meets a range between 90% and 100% of the subjects and enforceable standards, plus a documented commitment to maintain that level, plus 95% shall comply with three of the enforceable topics selected from the RCJS topic set enumerated in Table 1.

Level B may require that a justice center meets a range between 75% and 90% of the subjects and enforceable standards, plus a documented commitment to exceeding the limit of 90% at a preset time, plus 95% shall comply with two of enforceable topics selected from the RCJS topic set enumerated in Table 1.

Level C may require that a justice center meets a range between 50 and 75% of the subjects and enforceable standards, plus a documented commitment to exceeding the limit of 75% at a preset time, plus 95% shall comply with one of the enforceable topics selected from the RCJS topic set enumerated in Table 1.

The general goal of the certification process is to integrate a set of steps, stages, actions and activities to demonstrate the application, or lack thereof, of best practices worldwide level in the field of administration of justice and to evaluate the appropriate certification based on a universally applicable rating methodology. In this exemplary embodiment, a rating algorithm may contain the following dimensions:
(1) concepts or topics;
(2) categories of each of the concepts and topics, and
(3) the metric or standard that allows assessing the status, position or situation of each of (1) and (2).

The evaluation of the justice center is determined by:
(1) the perception and index of inhibition of the citizen towards judicial power;
(2) the perceptions and indicators of users of a Justice Center.
(3) the perception of the General Population of the Jurisdictions, on the way justice is administered therein.

As used herein, the term “User” refers to a person who uses the judicial system, from the basic definition that explains that the Judiciary as part of the Government of the People, was created to the serve citizens and foreigners, and that actual and potential users exist, but the appreciation both are important for the perception of state of law that prevails in the jurisdiction.

### Systems and Tools

The above described exemplary certification service model is akin to a consulting service engagement. It will be recognized by those skilled in the art that taking into account the number and volume of information involved, the distance, time, and other logistic factors, it is generally not possible or practical to perform the above mentioned certification activities without the assistance of computers, communication networks, and other enabling technology components, which will be further described in detail in this section.

### Computer System

The above described rating service model envision the establishment of an independent international institute to evaluate, classify and certify judicial systems in any jurisdiction worldwide via a mathematical formula. The disclosed rating service model further contemplates a system to manage, monitor and control the certification process in real time.

Specifically, embodiments of the present inventions may be implemented on one or more computing devices, including one or more servers, one or more client terminals, including computer terminals, a combination thereof, or on any of the myriad of computing devices currently known in the art, including without limitation, personal computers, laptops, notebooks, tablet computers, touch pads (such as the Apple iPad, SmartPad Android tablet, etc.), multi-touch devices, smart phones, personal digital assistants, other multi-function devices, stand-alone kiosks, etc.

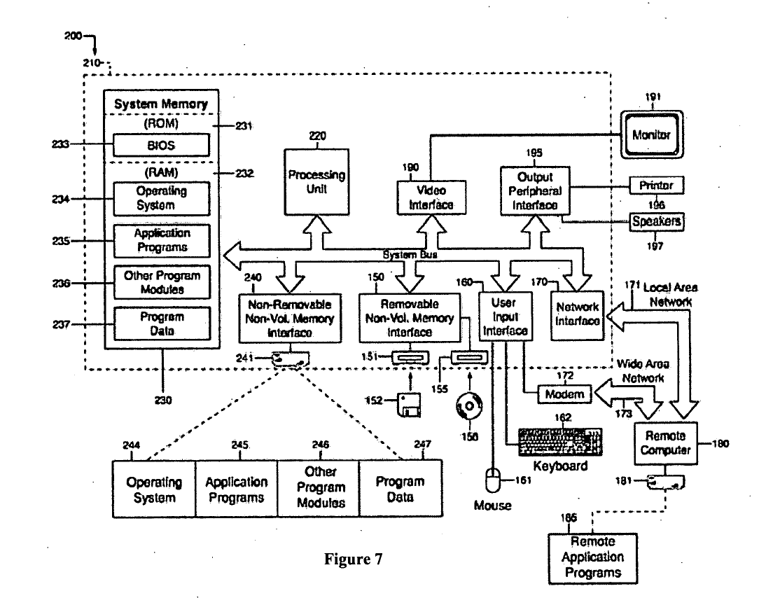

FIG. 7 illustrates an example of a suitable computing system environment 200 on which features of the invention may be implemented. The computing system environment 200 is only one example of a suitable computing environment and is not intended to suggest any limitation as to the scope of use or functionality of the invention. Neither should the computing environment 200 be interpreted as having any requirement relating to any one or combination of components illustrated in the exemplary operating environment 200.

The invention is operational with numerous other computing system environments or configurations. Examples of well-known computing systems, environments, and/or configurations that may be suitable for use with the invention include, but are not limited to, personal computers, server computers, hand-held, notebook or laptop devices, touch pads, multi-touch devices, smart phones, other multi-function devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by one or more computing devices. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 7, an exemplary system that may be used for implementing the invention includes a computing device 210 which may be used for implementing a client, server, mobile device or other suitable environment for the invention. Components of computing device 210 may include, but are not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computing device 210 typically includes a variety of computer readable media. Computer readable media may be defined as any available media that may be accessed by computing device 210 and includes both volatile and nonvolatile media, removable and non-removable media. By way of example, and not limitation, computer readable media may include computer storage media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computing device 210. Combinations of the any of the above should also be included within the scope of computer readable media.

The system memory 230 may include computer storage media in the form of volatile and/or nonvolatile memory such as read only memory (ROM) 231 and random access memory (RAM) 232. A basic input/output system 233 (BIOS), containing the basic routines that help to transfer information between elements within computing device 210, such as during start-up, is typically stored in ROM 231. RAM 232 typically contains data and/or program modules that are immediately accessible to and/or presently being operated on by processing unit 220. By way of example, and not limitation, FIG. 7 illustrates operating system 234, application programs 235, other program modules 236, and program data 237.

The computing device 210 may also include other removable/non-removable, volatile/nonvolatile computer storage media. By way of example only, FIG. 7 illustrates a hard disk drive 240 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 151 and optical disk drive 155 are typically connected to the system bus 121 by a removable memory interface, such as interface 150.

The drives and their associated computer storage media discussed above and illustrated in FIG. 7, provide storage of computer readable instructions, data structures, program modules and other data for the computing device 210. In FIG. 7, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 20 through input devices such as a keyboard 162 and pointing device 161, commonly referred to as a mouse, trackball, touch screen, or multi-touch input device. Other input devices (not shown) may include a microphone, joystick, game pad, satellite dish, scanner, movement sensor device such as the Microsoft Kinect or the like. These and other input devices are often connected to the processing unit 220 through a user input interface 160 that is coupled to the system bus, but may be connected by other interface and bus structures, such as a parallel port, game port or a universal serial bus (USB). A monitor 191 or other type of display device may also be connected to the system bus 221 via an interface, such as a video interface 190. In addition to the monitor, computers may also include other peripheral output devices such as speakers 197 and printer 196, which may be connected through an output peripheral interface 195.

The computing device 210 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computing device 210, although only a memory storage device 181 has been illustrated in FIG. 7. The logical connections depicted in FIG. 7 include a local area network (LAN) 171 and a wide area network (WAN) 173, but may also include other networks. Such networking environments are commonplace in offices, enterprise-wide computer networks, intranets and the Internet.

When used in a LAN networking environment, the computing device 210 is connected to the LAN 171 through a network interface or adapter 170. When used in a WAN networking environment, the computer 210 typically includes a modem 172 or other means for establishing communications over the WAN 173, such as the Internet. The modem 172, which may be internal or external, may be connected to the system bus 221 via the user input interface 160, or other appropriate mechanism. In a networked environment, program modules depicted relative to the computing device 210, or portions thereof, may be stored in the remote memory storage device. By way of example, and not limitation, FIG. 7 illustrates remote application programs 185 as residing on memory device 181. It will be appreciated that the network connections shown are exemplary and other means of establishing a communications link between the computers may be used.

Systems for controlling and monitoring the certification process

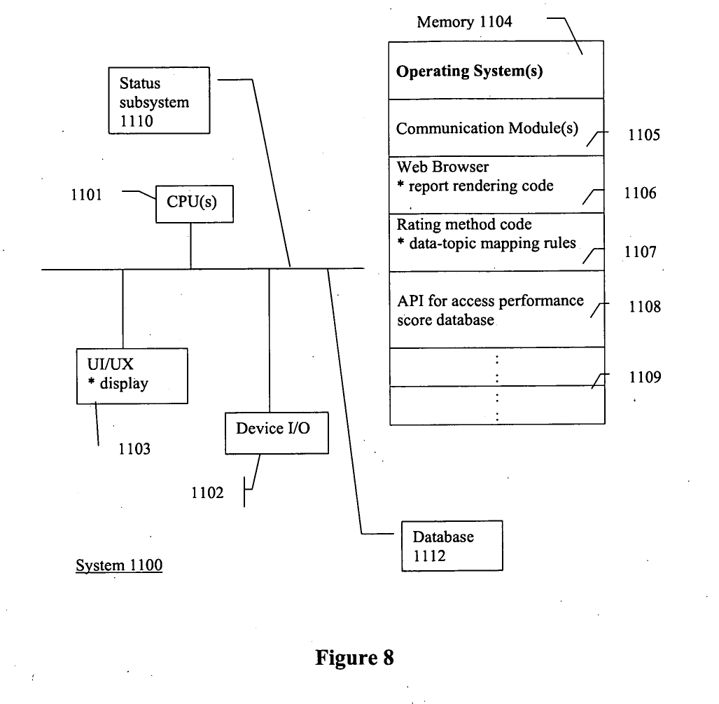

Referring to FIG. 8, systems in accordance with embodiments of the invention may include a status subsystem 1110, which may be maintained in real time, and may display information in various formats known in the art regarding the status or occurrence of relevant or critical events relating to the certification of a justice center/system. For example, subsystem 1110 may generate a rendering of a dashboard displaying progress of the certification process, current level of rating, comparison of other center performances, and funding levels, but not limited thereto. Such events may include reports or occurrences relating to on topics related to the certification process, reports on the level of adherence or non-adherence to international best practices, and other such factors. Information entered into the system may be categorized based on the topics and/or issues it relates to and then be displayed via the status subsystem. Exemplary categories may include, but not limited to quantitative types of topics, qualitative types of topics, or other user defined categories. In some embodiments, a predetermined data entry interface may automate the categorization process according to a predefined set of rules stored in the memory 1104. It will be noted that persons of ordinary skill in the art will understand that the embodiment and subsystems disclosed herein are exemplary and that the disclosed concepts may be implemented depending on design decisions, using variations of these subsystems which may be implemented as separate subsystems or combined into multi-faceted subsystems within the scope of the disclosed concepts.

The status subsystem may include a global status system which may be capable of displaying progress reports of any jurisdiction subject to the certification process, and may also be capable of identifying, reporting, and/or displaying jurisdiction or certification processes which may be in a situation of potential bias, failure or other such deviation.

The system may also include a measurement and evaluation subsystem which may track and display information relating to a comparison of the planned progress of the certification process versus the actual, reported progress of same. Exemplary measurement and evaluation subsystem may include a communication module 1106 to receive and transmit data to a remote user, a user interface that displays a process management flowchart. Such measurement and evaluation system may highlight areas where progress has been in accordance with the planned progress and/or areas that are deficient or delays, and the reasons therefor. The system may allow the evaluation results to be parameterized such that they can be compared across the certification and evaluation of other justice centers/systems based on these parameters. Any of the parameters that affects the certification process may be identified and used to sort or search a database of certification results of all evaluated justice centers/systems.

The system may include a user interface 1103, preferably a graphical user interface, that is easy to use and intuitive. The user interface may feature screens or website screens which can display information in different formats (such as signalized, classification tables, impact/complexity matrices, geo-referenced map, technical specifications, requirements, critical events reports or graphics, agreements, progress reports and any other methods known in the art). The information displayed may relate to the certification process, description, start dates, completion dates and days remaining, those responsible, areas in coordination, audio-visual evidence of current status, resources exercised, committed and available budget, certification process progress and change and trends in public perception and publications, or any other topics relating to the certification process.

The system may also include a subsystem for the assessment and evaluation of the standards used in the certification process. This includes an evaluation of the standards applied in each jurisdiction by agents and/or other users specializing in same, the study and approval of such standards by such agents and users and the recordation within the database of the system of such standards and the evaluation applied to same.

A meeting monitor subsystem may also be included that may help organize and coordinate meetings of all personnel working on the various aspects of the certification process. The monitoring subsystem may also provide a method to capture, memorialize, or otherwise summarize requirements or critical events discussed at the meeting or any agreements discussed or reached in same.

An alert and alarm subsystem may be included to send alerts to personnel working on the various aspects of the certification process. Such alerts may be sent, for example, when a component of the certification process reports a success, failure or bias. These alerts may be sent via email, SMS, voicemail, or any other means of communicating such alerts known in the art.

The system may include a database subsystem 1109 which maintains all information gathered and relied upon during the certification process. A control center subsystem may govern data entry into the database. The control center system will allow agents to enter information relating to such events directly via a computer terminal , mobile phone or any other computing device, via access to a database, website or any other medium known in the art where such inform may be entered. The information may be categorized, processed, analyzed and otherwise manipulated through the use of computing devices having access to same. The control center may be a website or a program running locally on a server, or any other suitable solution known in the art which allows users to input information into a database. The control center and database may include search and query tools as well as reporting tools.

Support and monitoring subsystems may be included to provide information on agreements, requirements, instructions, milestones, and/or events ongoing or required for effective implementation. This subsystem may also include a notification mechanism to disseminate the status of the certification process in real time via email, SMS or any other medium known in the art.

A control information subsystem may contain data and information on topics, categories and metrics involved in the certification process for judicial centers/systems. This subsystem may be part of the Control Center, or as discussed above more generally, may optionally be implemented as a separate subsystem.

The system may be built to support linking of information with the general topics to which it relates. Tracking, searching and analysis of the information related to such topics may be accomplished via the use of such linking information. Similarly, requests for access to public information may be tracked and linked to the related certification process, trials, results or other indicators used throughout the certification process.

The system may allow the preparation of reports relating to the certification process, and such reports may be generated and/or dynamically updated in real time based on information contained in the system and/or its database. Such reports may allow users or agents to add notes, comments, conclusions or recommendations to the reports for evaluation by other personnel working on same.

The system may dynamically generate requests for information to justice centers that are in the certification process. Such requests may be sent selectively to some such justice centers, or globally to all such justice centers.

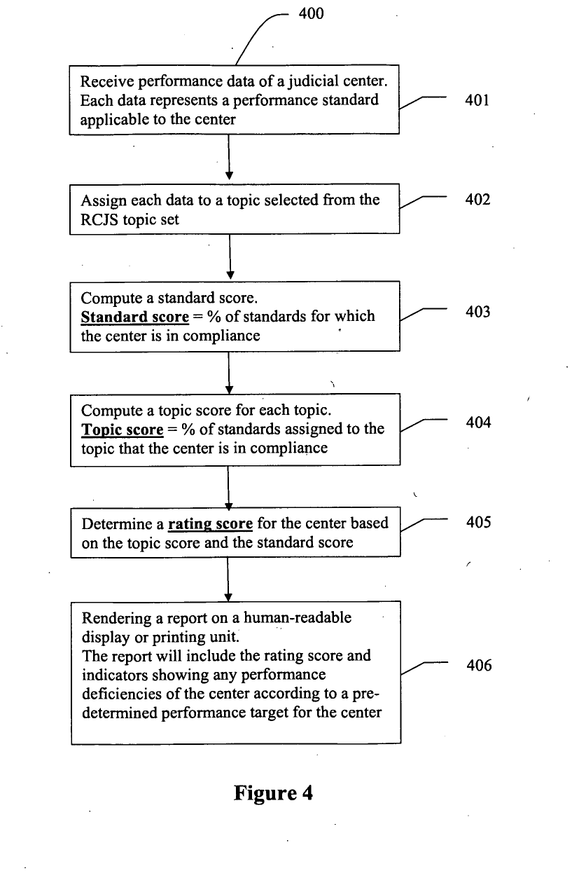

FIG. 4 shows a flowchart diagram illustrating an exemplary embodiment of a judicial performance evaluation method 400 utilizing systems and tools as described above. Method 400 begins with step 401 in which performance data of a judicial center is received by a system 1100. Performance data may be received via any number of routes. In some exemplary embodiments, data is entered in the computer system manually via an input device such as a keyboard, mouse, touchscreen, etc. Here each data point represents a performance evaluation standard that is applicable to the judicial center. Typically performance standards data may be in the form of a survey score or some other qualitative descriptor describing the state of performance as measured by that particular standard. In this case, the system may further include a compliance table to determine whether the data point is representing a compliance state or non-compliance state. A conversion step can then be performed to convert the data point into either “1” representing a compliance state, or “0” representing a non-compliant state. Alternatively, the data point is already representing a compliant/non-compliant state. In that case, the data point is then assigned to a topic in step 402. Once data is received by the system, the processor may then be instructed to assign each data to a topic according to a mapping rule scored in the memory of system 1100. In a preferred embodiment, the mapping rule may be RCJS mapping rule and the topics are selected from RCJS topic set.

Next, in step 403, the system computes a standard score and a topic score for each topic. In a preferred embodiment, the standard score is the percentage of standards for which the judicial center is in compliance. In step 404, the system computes a topic score for each of the topics. In a preferred embodiment, the topic score is the percentage of standards assigned to the topic for which the judicial center is in compliance. It should be noted where that the order of 403 and 404, while shown in sequence, is not necessary to be computed in sequence. The topic score may be computed first, or they can be computed at the same time in a parallel processor environment.

Next, in step 405, a rating score is determined based on the standard score and the topic scores. It will be understood by those skilled in the art that there are numerous options for how to define the rating score based on the standard and topic scores. In a preferred embodiment, a 3-letter (i.e. A, B, C) rating as described above is used.

In step 406, the system renders a report on a human-readable display or a printing unit. The display and printing units are not particularly limited. Any suitable display and printing device may be used. On an interactive display, the report may include interactive elements to allow a user to examine the scores and data. For example, a user may interact with the report to play with different input parameters or compare with reports of other judicial centers.

Additionally, in some embodiments, when the system is being used during certification process, the reporting step may involve rendering an alert report when an event that causes the judicial performance rating to drop. In some other embodiments, when the system is being used for monitoring and improving performance, the report may be an interactive report that allows the user to explore the scores, performance data, and perform multi-dimensional analysis such as clustering, time series, regression, or other data-mining techniques to identify factors influencing the performance rating.

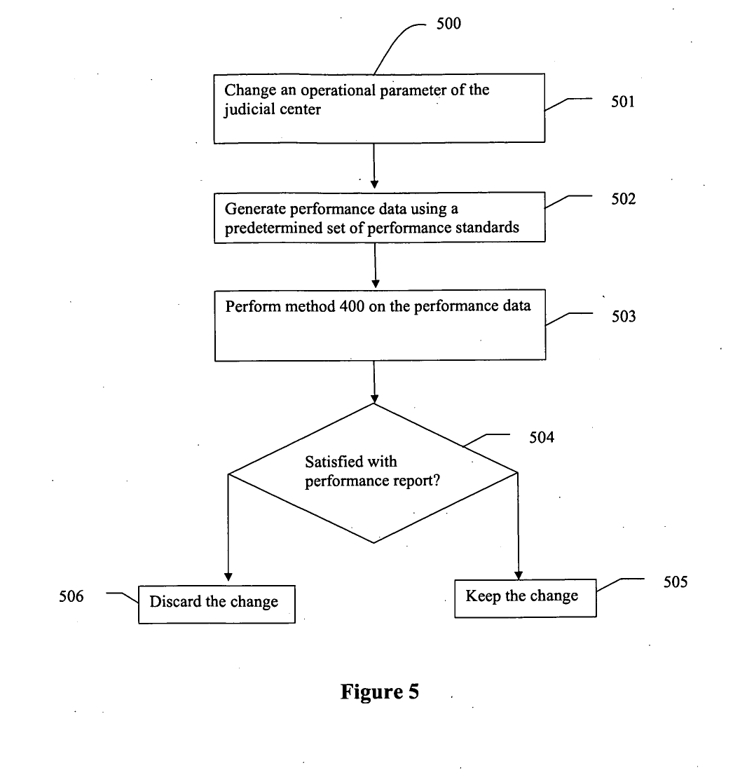

FIG. 5 illustrates an exemplary use of the system 1100 to improve performance of a judicial center. In this example, an operating parameter is changed first in step 501 and new performance data is generated is step 502 to obtain a new rating in step 503. Next, in stop 504, a decision is made to either retain the change or discard the change based on the new rating. This example illustrates the iterative capability of the system and also the evidence-based approach for improving judicial center performance. Those skilled in the art will recognize that operation parameters do not need to be changed one at a time. When multiple changes are made, the decision step 504 may further include a multi-dimensional analysis to determine the true impact of the change and suggest appropriate further changes. In this way, optimization of the judicial center can be achieved at faster rate and lower cost.

Although the present invention has been described in terms of specific exemplary embodiments and examples, it will be appreciated that the embodiments disclosed herein are for illustrative purposes only and various modifications and alterations might be made by those skilled in the art without departing from the spirit and scope of the invention as set forth in the following claims.

TABLE 1
DIRECT CORRELATION STANDARDS//ITEMS OR ISSUES WITH EACH FORUM OR PROGRAM

| | | FORUMS | | | PROGRAMS | | |
|---|---|---|---|---|---|---|---|
| | | International | Counsel for | Summit for | Global | | |
| | | Framework | the | Judicial | Measures of | | |
| | | for Court | Execution of | Ibero- | Court | | |
| | | Excellence | Judicial Power | americana | Performance | | |
| ° | Topic | (IFCE) | (CEPEJ) | (CJI) | (GMCP) | CourtTools | Sum |
| | Transparency | 5 | 5 | 34 | 2 | 4 | 50 |
| I | Protection of Dates | 7 | 6 | 25 | 0 | 0 | 38 |
| II | Access to the | 13 | 3 | 151 | 7 | 1 | 175 |
| | Judiciary | | | | | | |
| V | Oral Argument | 0 | 3 | 19 | 1 | 0 | 23 |
| | Mediums for | 5 | 4 | 34 | 0 | 1 | 44 |
| | Communication | | | | | | |
| I | Ethics | 1 | 4 | 105 | 1 | 0 | 111 |
| II | Judicial Profile | 2 | 3 | 115 | 1 | 1 | 122 |
| III | Document and | 3 | 2 | 21 | 3 | 0 | 29 |
| | Information Control | | | | | | |
| X | Rights of Users | 8 | 6 | 92 | 5 | 5 | 116 |
| | Rights of Victims | 7 | 5 | 98 | 2 | 4 | 116 |
| I | International | 0 | 2 | 24 | 0 | 0 | 26 |
| | Judicial Cooperation | | | | | | |
| II | Judicial Certainty | 7 | 3 | 15 | 9 | 0 | 34 |
| III | Judicial Administration | 7 | 3 | 38 | 9 | 14 | 71 |
| | and Management | | | | | | |
| IV | Productivity | 18 | 6 | 14 | 8 | 9 | 55 |
| V | Judicial Careers | 3 | 2 | 46 | 1 | 2 | 54 |
| VI | Efficiency and | 10 | 2 | 26 | 3 | 13 | 54 |
| | Utilization of Resources | | | | | | |
| VII | Economic and | 0 | 2 | 0 | 0 | 0 | 2 |
| | Demographic Context | | | | | | |
| VIII | Legal Profession | 0 | 1 | 0 | 0 | 0 | 1 |
| | 18 Topics | 96 | 62 | 857 | 52 | 54 | 1121 |

TABLE 2

| | | | # of Evidences | | | | | | TOTAL |
|---|---|---|---|---|---|---|---|---|---|
| | # of | # of | | Survey | | Investi- | | | # of |
| Category | Standards | Indicators | Documents | Questions | Reports | gations | Studies | Other | EVIDENCES |
| ACCESS TO JUSTICE | 109 | 562 | 267 | 378 | 41 | 37 | 19 | 0 | 742 |
| RIGHTS OF USERS | 79 | 407 | 179 | 334 | 31 | 25 | 18 | 0 | 587 |
| RIGHTS OF VICTIMS | 87 | 472 | 214 | 353 | 40 | 27 | 18 | 0 | 652 |
| INDEPENDENCE | 204 | 601 | 335 | 323 | 13 | 10 | 21 | 23 | 725 |
| JUDGES ETHICS | 73 | 160 | 93 | 121 | 0 | 3 | 5 | 0 | 222 |
| MEDIA RELATIONSHIP | 14 | 47 | 19 | 21 | 1 | 2 | 4 | 0 | 47 |
| EFFICIENCY AND | 123 | 483 | 235 | 334 | 63 | 8 | 47 | 16 | 703 |
| EFFICTIVENESS | | | | | | | | | |
| IMPLEMENTATION OF | 16 | 76 | 21 | 203 | 22 | 0 | 3 | 0 | 250 |
| JUDICIAL RESOLUTIONS | | | | | | | | | |
| QUALIFY | 67 | 330 | 183 | 203 | 13 | 4 | 20 | 11 | 434 |
| MEDIA RELATIONSHIP | 2 | 12 | 6 | 4 | 1 | 1 | 0 | 0 | 12 |
| TRANSPARENCY | 51 | 229 | 110 | 122 | 19 | 0 | 18 | 0 | 269 |
| TOTAL | 487 | 1875 | 947 | 1157 | 136 | 55 | 105 | 39 | 2439 |

What is claimed is:

1. A computer-implemented method for evaluating and monitoring the performance of a judicial center, comprising:
receiving performance data of the judicial center into a computer system via an input unit, wherein each performance data point corresponds to a performance measurement standard applicable to the judicial center, and wherein said computer system comprises a memory unit and a processing unit programmed to perform the steps of:
mapping each performance data point to a topic selected from the RCJS topic set, wherein said mapping is performed in accordance with a set of predetermined mapping rules stored in the memory unit of the computer system;
calculating a standard compliance score based on the number of standards for which the judicial center is in compliance and a topic compliance score for each topic based on the number of standards assigned to the topic for which the judicial center is in compliance;
determining a rating score for the justice center based on the standard compliance score and the topic compliance score(s); and
rendering a report on a human-readable display or printing unit upon receiving an inquiry command, wherein said report comprises a performance analysis indicating the rating score and any performance deficiencies in the judicial center according to a pre-determined performance target of the judicial center.

2. The method of claim 1, wherein the standard compliance score is a percentage score representing the percentage of the number of standards for which the judicial center is in compliance.

3. The method of claim 1, wherein the topic compliance score is a percentage score representing the percentage of the number of standards assigned to the topic for which the judicial center is in compliance with.

4. The method of claim 1, wherein the mapping rule is the RCJS mapping rule.

5. The method of claim 1, wherein the input unit is a mobile device configured with a graphical user interface for entering values corresponding to the performance standards.

6. The method of claim 1, wherein the performance standards are selected from at least one of the 9 RCJS sources.

7. The method of claim 1, wherein the performance standards include standards from all 9 RCJS sources.

8. The method of claim 1, wherein the topic is further limited to one selected from the group consisting of access to justice, independence, transparency, and efficacy and effectiveness.

9. The method of claim 1 wherein the method is automatically repeated to monitor the performance of the judicial center in real-time.

10. The method of claim 1 further comprising an alerting step of sending an alert to a pre-determined receiver when the rating score of the judicial center is below a predetermined rating.

11. A method of comparing judicial center performance, comprising:
obtaining a rating score and optionally any of the standard compliance scores, the topic compliance scores, or individual data point for each of a plurality of judicial centers according to the method of claim 1; and,
arranging the scores in a human-readable representation, selected from a list, a table, a chart, a graph, or a combination thereof.

12. The method of claim 11 further comprising a step of receiving a user inquiry via an interactive graphical user interface regarding the selection of scores or data points to obtain.

13. The method of claim 11 further comprising a step of automatically generating a multi-dimensional comparison report comprising the arranged representation of the scores and multi-dimensional analysis of the judicial center.

14. A non-transitory computer readable-medium for evaluating and monitoring the performance of a judicial center, comprising instructions stored thereon, that when executed on processor, performs the steps of:
receiving performance data of the judicial center into a memory unit, wherein each performance data point represent a performance measurement standard applicable to the judicial center, and wherein said computer system comprises a processing unit and a memory unit;
mapping each performance data point to a topic selected from the RCJS topic set, wherein said mapping is performed in accordance with a set of predetermined mapping rules stored in the memory unit of the computer system;
computing a standard compliance score based on the number of standards for which the judicial center is in compliance and a topic compliance score based on the number of standards assigned to a topic for which the judicial center is in compliance;
calculating a rating score for the justice center based on the standard compliance score and the topic scores; and
rendering a report on a human-readable display or printing unit upon receiving an inquiry command, wherein said report comprises a performance analysis indicating the rating score and any performance deficiencies in the judicial center according to a pre-determined performance target of the judicial center.

15. The medium of claim 14 further comprising instructions for directing the processor to render a human-readable representation of the scores on a display unit in an interactive user-interface.

16. A computer-implemented information system for evaluating and monitoring the performance of one or more judicial center(s), comprising:
a databases subsystem configured to receive judicial performance rating scores, standard compliance scores, and topic compliance scores;
a measurement and evaluation subsystem comprising a memory unit and a processing unit programmed to perform the steps of:
receiving performance data of the judicial center(s) via an input unit, wherein each data point corresponds to a performance measurement standard applicable to the judicial center(s);
mapping each performance data point to a topic selected from the RCJS topic set, wherein said mapping is performed in accordance with a set of predetermined mapping rules stored in the memory unit;
computing a standard compliance score based on the number of standards for which the judicial center is in compliance and a topic compliance score for each topic based on the number of standards assigned to the topic for which the judicial center is in compliance;
calculating a rating score for the justice center(s) based on the standard scores and the topic scores; and
transmitting the scores to the database subsystem for storage; and
a human-readable output unit for rendering a report comprising rating scores and performance analyses of a judicial center.

17. The system of claim 16 wherein the processing unit is further programmed to render a human-readable representation of the scores in an interactive user interface.

18. A method for monitoring and improving the performance of a judicial center, comprising:
changing an operational parameter or procedure of the judicial center;
generating performance data using a pre-selected set of performance standards applicable to the judicial center;
obtaining a performance report according to method of claim 1; and
retaining the change of operational parameter or procedure of the judicial center if the report indicates a satisfactory level of performance, or discarding the change if the report indicates an unsatisfactory level of performance.

19. The method of claim 18 wherein the parameter or procedure is selected from one that has been published as a best practice.

20. The method of claim 18, further comprising publishing the changed parameter or procedure as a best practice if the performance report indicates an improvement.
